(19) United States
(12) Patent Application Publication
(10) Pub. No.: US 2026/0225665 A1
(43) Pub. Date: Aug. 6, 2026

(54) SYSTEMS AND METHODS FOR AUTOMATED FRONT FENDERS

(71) Applicant: CNH INDUSTRIAL AMERICA LLC, New Holland, PA (US)

(72) Inventors: Lorenzo GOMEZ, New Holland, PA (US); Mark KLASSEN, New Holland, PA (US); David GLORIO, New Holland, PA (US); Anna REISENAUER, New Holland, PA (US)

(73) Assignee: CNH INDUSTRIAL AMERICA LLC, New Holland, PA (US)

(21) Appl. No.: 19/042,902

(22) Filed: Jan. 31, 2025

(51) Int. Cl. B62D 25/18

(52) U.S. Cl. CPC B62D 25/188

(57) ABSTRACT

A vehicle may include a chassis. The vehicle may include an axle coupled to the chassis and a first tractive element coupled to the axle. The vehicle may include a first debris shield positioned proximate to the first tractive element and a first actuator operatively coupled to the first debris shield. The vehicle may include one or more processors communicably coupled to the first actuator and a computer-readable, non-transitory storage medium containing instructions that when executed by the one or more processors cause the one or more processors to perform a method of steps comprising (i) receiving steering data including a steering angle of the first tractive element and (ii) controlling the first actuator to adjust the first debris shield from a first debris shield first position to a first debris shield second position based in part on the steering angle received in the steering data.

### BACKGROUND

The present disclosure relates generally to vehicles. Vehicles, such as agricultural vehicles, often include wheel fenders to shield operators, portions of the vehicle (e.g., the windshield), and/or surrounding areas from debris being launched by moving tires. When a tire is turned to steer the vehicle, the debris is launched from the tire at an angle that substantially corresponds with the steered angle.

### SUMMARY

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

In some aspects, the techniques described herein relate to a vehicle including: a chassis; an axle coupled to the chassis; a first tractive element coupled to the axle; a first debris shield positioned proximate to the first tractive element; a first actuator operatively coupled to the first debris shield; one or more processors communicably coupled to the first actuator; and a computer-readable, non-transitory storage medium containing instructions that when executed by the one or more processors cause the one or more processors to perform a method of steps including: receiving steering data including a steering angle of the first tractive element; and controlling the first actuator to adjust the first debris shield from a first debris shield first position to a first debris shield second position based in part on the steering angle received in the steering data.

In some aspects, the techniques described herein relate to a vehicle, further including: an operator seat; wherein the first debris shield extends circumferentially about at least a portion of the first tractive element such that the first debris shield is positioned, at least in part, between the operator seat and the first tractive element along a tractive element axis of the first tractive element.

In some aspects, the techniques described herein relate to a vehicle, wherein controlling the first actuator includes transmitting a first instruction to the first actuator that causes the first actuator to maintain an orientation relative to the first tractive element.

In some aspects, the techniques described herein relate to a vehicle, wherein the orientation relative to the first tractive element is such that the first debris shield maintains a position between the operator seat and the first tractive element during steering of the first tractive element.

In some aspects, the techniques described herein relate to a vehicle, wherein the method further includes receiving the steering data from a steering sensor that measures a position of a steering column of the vehicle.

In some aspects, the techniques described herein relate to a vehicle, further including: a steering arm operatively coupled to the first tractive element; wherein the method further includes receiving the steering data from a steering sensor configured to detect a position of the steering arm.

In some aspects, the techniques described herein relate to a vehicle, wherein the method further includes: setting a first debris shield limit for the first debris shield associated with a threshold steering angle; receiving an indication that a current steering angle is at the threshold steering angle; and in response to at least receiving the indication that the current steering angle is at the threshold steering angle, controlling the first actuator to stop adjusting the first debris shield.

In some aspects, the techniques described herein relate to a vehicle, further including: a second tractive element coupled to the axle; a second debris shield positioned proximate to the second tractive element; and a second actuator operatively coupled to the second debris shield; wherein the method further includes: controlling the second actuator to adjust the second debris shield from a second debris shield first position to a second debris shield second position based in part on the steering angle; and in response to receiving the indication that the current steering angle is at the threshold steering angle, controlling the second actuator to continue adjusting the second debris shield to a second debris shield third position.

In some aspects, the techniques described herein relate to a vehicle, wherein the method further includes: determining a first debris shield desired position based in part on the steering angle; comparing a first debris shield angle of the first debris shield with the first debris shield angle; and in response to at least the first debris shield angle exceeding a threshold from the steering angle of the first tractive element, controlling the first actuator to adjust the first debris shield to the first debris shield desired position.

In some aspects, the techniques described herein relate to a vehicle, wherein the method further includes: receiving front implement data including a front implement position of a front implement coupled to the vehicle; comparing the front implement position and the first debris shield angle; determining the first debris shield desired position based in part on the steering angle and the front implement position; and controlling the first actuator to adjust the first debris shield to the first debris shield first position.

In some aspects, the techniques described herein relate to a vehicle, receiving an indication of a collision; and controlling the first actuator to reverse movement of the first actuator until no longer receiving the indication of the collision.

In some aspects, the techniques described herein relate to a vehicle, wherein the first debris shield is mechanically decoupled from an articulation of the first tractive element.

In some aspects, the techniques described herein relate to a vehicle, wherein actuation of the first debris shield is mechanically decoupled from articulation of the first tractive element.

In some aspects, the techniques described herein relate to a vehicle, wherein the method further including: receiving a tread setting of the vehicle; and determining a first debris shield limit based at least in part on the tread setting.

In some aspects, the techniques described herein relate to a vehicle, further including a clutch cooperatively coupled to the first debris shield and adapted to engage in response to receiving force satisfying a threshold force.

In some aspects, the techniques described herein relate to a vehicle, wherein the method further includes: receiving speed data including a current speed of the vehicle; and in response to the current speed not satisfying a speed threshold, controlling the first actuator to adjust the first debris shield to a third position such that in the third position the first debris shield is misaligned with the first tractive element.

In some aspects, the techniques described herein relate to a vehicle, wherein the method further includes: receiving speed data including a current speed of the vehicle; and in response to the current speed not satisfying a speed threshold, controlling the first actuator to rotate the first debris shield circumferentially about the first tractive element.

In some aspects, the techniques described herein relate to a vehicle, further including: determining the steering angle of the first tractive element based at least in part on the steering data; and in response to determining the steering angle of the first tractive element, transmitting a first instruction to the first actuator to adjust a position of the first debris shield.

In some aspects, the techniques described herein relate to a system including: a debris shield; an actuator operatively coupled to the debris shield; one or more processors communicably coupled to the actuator; and a computer-readable, non-transitory storage medium containing instructions that when executed by the one or more processors cause the one or more processors to perform a method of steps including: receiving steering data including a steering angle of a tractive element; and controlling the actuator to adjust the debris shield from a debris shield first position to a debris shield second position based in part on the steering angle received in the steering data.

In some aspects, the techniques described herein relate to a method of operating an agricultural vehicle, the method including: receiving, by one or more processors, steering data of the agricultural vehicle that includes a steering angle of a tractive element of the agricultural vehicle; determining, by the one or more processors, a desired debris shield position based at least in part on the steering angle of the tractive element of the agricultural vehicle; and controlling an actuator to adjust a first debris shield coupled to the agricultural vehicle from a debris shield first position to a debris shield second position based in part on the steering angle received in the steering data.

### BRIEF DESCRIPTION OF THE DRAWINGS

FIG. 1 is a perspective view of an example vehicle, according to an embodiment.

FIG. 2 is a schematic block diagram of the vehicle of FIG. 1, according to an embodiment.

FIG. 3 is a schematic block diagram of the driveline of the vehicle of FIG. 1, according to an embodiment.

FIG. 4 is a top view of the vehicle of FIG. 1, according to an embodiment.

FIG. 5 is a top view of the vehicle of FIG. 1 in a turning event, according to an embodiment.

FIG. 6 is a top view of the vehicle of FIG. 1 in a turning event with a debris shield positional limit, according to an embodiment.

FIG. 7 is a breakout view of a debris shield system of the vehicle of FIG. 1, according to an embodiment.

FIG. 8 is a top view of the vehicle of FIG. 1 with a front implement in a turning event with a debris shield positional limit, according to an embodiment.

FIG. 9 is a top view of the vehicle of FIG. 1 with laterally adjusting debris shields, according to an embodiment.

FIG. 10 is a top view of the vehicle of FIG. 1 operating in a visibility mode, according to an embodiment.

FIG. 11 is a side view of the vehicle of FIG. 1 according to an embodiment.

FIG. 12 is a side view of the vehicle of FIG. 1 operating in a visibility mode, according to an embodiment.

FIG. 13 is a top view of the vehicle of FIG. 12 operating in the visibility mode, according to an embodiment.

FIG. 14 is a schematic block diagram of a control system of the vehicle of FIG. 1, according to an embodiment.

FIG. 15 is a flowchart of a method of operating the vehicle of FIG. 1, according to an embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Traditional fenders on vehicles are statically fixed to the vehicle, requiring larger-than-necessary fenders to shield a range of area that covers a range of steering angles. These larger-than-necessary fenders block a view of the contact area between the tire and the ground, leading to reduced ground visibility for an operator or autonomous control system of the vehicle. Other traditional fenders are mechanically actuated by mechanical linkages between the traditional fenders and articulated components of a steering system of the vehicle, such that movement of the articulated component is transferred the fender to actuate it. However, these traditional fenders do now allow for actuation of the fender independently of steering of the vehicle. Further, such traditional fenders may not be able to be utilized on vehicles of different tread settings (e.g., a distance between front tires), thus requiring custom installation and mounting for different tread settings.

According to at least one embodiment of the disclosure herein, a vehicle may include a fender (also referred to herein as a debris shield) that is actuated such that the fender's position maintains alignment with a wheel during steering. The fender is mechanically decoupled from an articulation of the vehicle's steering system by being mounted to the frame of the vehicle. The fender may be actuated by an electromechanical actuator (e.g., a motor) or hydraulic actuator rather than being actuated by a mechanical linkage between the fender and an articulated portion of the vehicle. The vehicle includes a control system that receives inputs of the current steering angle (or desired steering angle) and determines a desired fender position such that the fender is maintained in an orientation relative to the vehicle and the wheel so that during operation the fender shields the vehicle from projectile debris from the wheel and/or adjusts to increase ground visibility. Maintaining an orientation relative to the vehicle and the wheel may include laterally adjusting the fender along an axis parallel to the axle of the vehicle. In some embodiments, the fender is additionally or alternatively rotated/pivoted to maintain alignment with the steered wheel. By actuating the fender in accordance with the steering of the wheel, ground visibility is increased for an operator of the vehicle and/or automated vehicle sensors/controls (e.g., cameras) while maintaining protection from projectile debris.

### Overall Vehicle

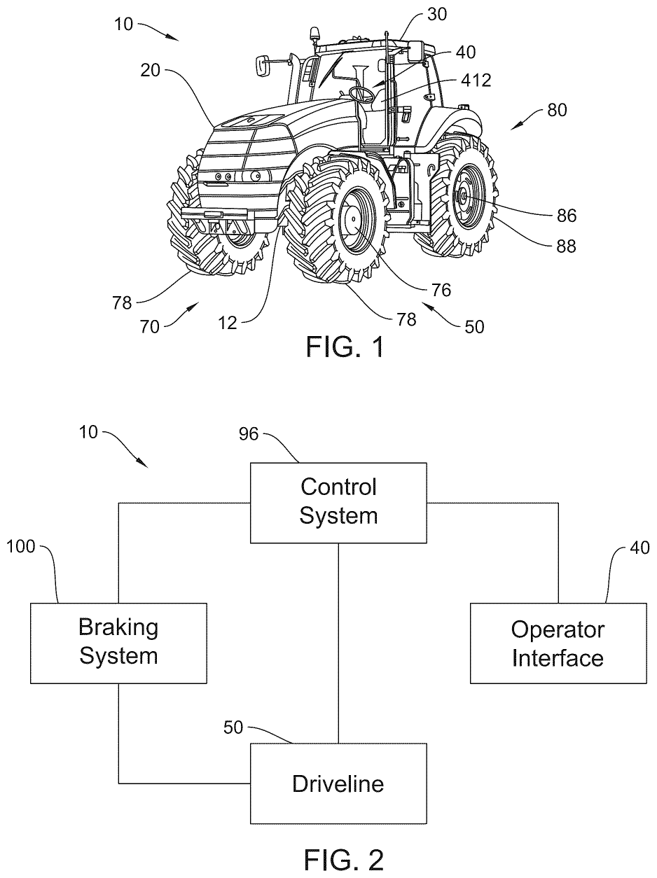

According to the exemplary embodiment shown in FIGS. 1-3, a machine or vehicle (e.g., a non-articulated vehicle, an articulated vehicle, etc.), shown as vehicle 10, includes a chassis, shown as frame 12; a body assembly, shown as body 20, coupled to the frame 12 and having an occupant portion or section, shown as cab 30; operator input and output devices, shown as operator interface 40, that are disposed within the cab 30; a drivetrain, shown as driveline 50, coupled to the frame 12 and at least partially disposed under the body 20; a vehicle braking system, shown as braking system 100, coupled to one or more components of the driveline 50 to facilitate selectively braking the one or more components of the driveline 50; and a vehicle control system, shown as control system 96, coupled to the operator interface 40, the driveline 50, and the braking system 100. In other embodiments, the vehicle 10 includes more or fewer components.

The chassis of the vehicle 10 may include a structural frame (e.g., the frame 12) formed from one or more frame members coupled to one another (e.g., as a weldment). Additionally or alternatively, the chassis may include a portion of the driveline 50. By way of example, a component of the driveline 50 (e.g., the transmission 56) may include a housing of sufficient thickness to provide the component with strength to support other components of the vehicle 10.

According to an exemplary embodiment, the vehicle 10 is an off-road machine or vehicle. In some embodiments, the off-road machine or vehicle is an agricultural machine or vehicle such as a tractor, a telehandler, a front loader, a combine harvester, a grape harvester, a forage harvester, a sprayer vehicle, a speedrower, and/or another type of agricultural machine or vehicle. In some embodiments, the off-road machine or vehicle is a construction machine or vehicle such as a skid steer loader, an excavator, a backhoe loader, a wheel loader, a bulldozer, a telehandler, a motor grader, and/or another type of construction machine or vehicle. In some embodiments, the vehicle 10 includes one or more attached implements and/or trailed implements such as a front mounted mower, a rear mounted mower, a trailed mower, a tedder, a rake, a baler, a plough, a cultivator, a rotavator, a tiller, a harvester, and/or another type of attached implement or trailed implement.

According to an exemplary embodiment, the cab 30 is configured to provide seating for an operator (e.g., a driver, etc.) of the vehicle 10. In some embodiments, the cab 30 is configured to provide seating for one or more passengers of the vehicle 10. According to an exemplary embodiment, the operator interface 40 is configured to provide an operator with the ability to control one or more functions of and/or provide commands to the vehicle 10 and the components thereof (e.g., turn on, turn off, drive, turn, brake, engage various operating modes, raise/lower an implement, etc.). The operator interface 40 may include one or more displays and one or more input devices. The one or more displays may be or include a touchscreen, an LCD display, a LED display, a speedometer, gauges, warning lights, etc. The one or more input device may be or include a steering wheel, a joystick, buttons, switches, knobs, levers, an accelerator pedal, a brake pedal, etc.

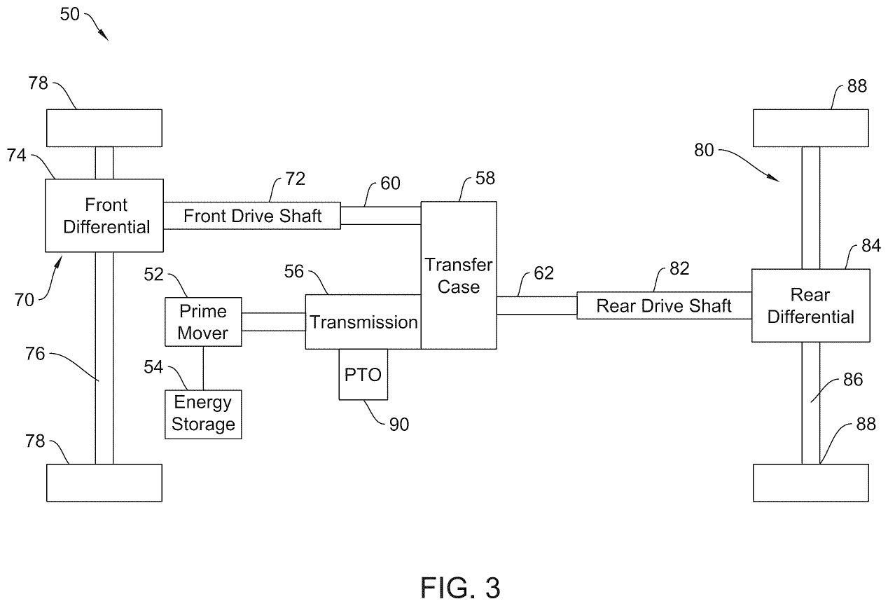

According to an exemplary embodiment, the driveline 50 is configured to propel the vehicle 10. As shown in FIG. 3, the driveline 50 is an electric driveline that includes a primary driver (e.g., prime mover, etc.), shown as prime mover 52, and an energy storage system (e.g., energy storage, etc.), shown as high voltage system 54. For example, the prime mover 52 may be electrically coupled to (e.g., in electrical communication with, etc.) the high voltage system 54 and may consume electrical energy from the high voltage system 54 in order to propel the vehicle 10. In some embodiments, the driveline 50 is a fuel cell electric driveline that includes the prime mover 52 and the energy storage system is a fuel cell (e.g., that stores hydrogen, that produces electricity from the hydrogen, etc.). In some embodiments, the driveline 50 is a hybrid driveline that includes (i) the prime mover 52 and an internal combustion engine and (ii) the high voltage system 54 and a fuel tank. In other embodiments, the driveline 50 is a conventional driveline where the primary driver is an internal combustion engine and the energy storage system is a fuel tank. The internal combustion engine may be a spark-ignition internal combustion engine or a compression-ignition internal combustion engine that may use any suitable fuel type (e.g., diesel, ethanol, gasoline, natural gas, propane, etc.).

As shown in FIG. 3, the driveline 50 includes a transmission device (e.g., a gearbox, a continuous variable transmission (“CVT”), etc.), shown as transmission 56, coupled to the prime mover 52; a power divider, shown as transfer case 58, coupled to the transmission 56; a first tractive assembly, shown as front tractive assembly 70, coupled to a first output of the transfer case 58, shown as front output 60; and a second tractive assembly, shown as rear tractive assembly 80, coupled to a second output of the transfer case 58, shown as rear output 62. According to an exemplary embodiment, the transmission 56 has a variety of configurations (e.g., gear ratios, etc.) and provides different output speeds relative to a mechanical input received thereby from the prime mover 52. In some embodiments (e.g., in electric driveline configurations, in hybrid driveline configurations, etc.), the driveline 50 does not include the transmission 56. In such embodiments, the prime mover 52 may be directly coupled to the transfer case 58. According to an exemplary embodiment, the transfer case 58 is configured to facilitate driving both the front tractive assembly 70 and the rear tractive assembly 80 with the prime mover 52 to facilitate front and rear drive (e.g., an all-wheel-drive vehicle, a four-wheel-drive vehicle, etc.). In some embodiments, the transfer case 58 facilitates selectively engaging rear drive only, front drive only, and both front and rear drive simultaneously. In some embodiments, the transmission 56 and/or the transfer case 58 facilitate selectively disengaging the front tractive assembly 70 and the rear tractive assembly 80 from the prime mover 52 (e.g., to permit free movement of the front tractive assembly 70 and the rear tractive assembly 80 in a neutral mode of operation). In some embodiments, the driveline 50 does not include the transfer case 58. In such embodiments, the prime mover 52 or the transmission 56 may directly drive the front tractive assembly 70 (i.e., a front-wheel-drive vehicle) or the rear tractive assembly 80 (i.e., a rear-wheel-drive vehicle).

As shown in FIGS. 1 and 3, the front tractive assembly 70 includes a first drive shaft, shown as front drive shaft 72, coupled to the front output 60 of the transfer case 58; a first differential, shown as front differential 74, coupled to the front drive shaft 72; a first axle, shown front axle 76, coupled to the front differential 74; and a first pair of tractive elements, shown as front tractive elements 78, coupled to the front axle 76. In some embodiments, the front tractive assembly 70 includes a plurality of front axles 76. In some embodiments, the front tractive assembly 70 does not include the front drive shaft 72 or the front differential 74 (e.g., a rear-wheel-drive vehicle). In some embodiments, the front drive shaft 72 is directly coupled to the transmission 56 (e.g., in a front-wheel-drive vehicle, in embodiments where the driveline 50 does not include the transfer case 58, etc.) or the prime mover 52 (e.g., in a front-wheel-drive vehicle, in embodiments where the driveline 50 does not include the transfer case 58 or the transmission 56, etc.). The front axle 76 may include one or more components.

As shown in FIGS. 1 and 3, the rear tractive assembly 80 includes a second drive shaft, shown as rear drive shaft 82, coupled to the rear output 62 of the transfer case 58; a second differential, shown as rear differential 84, coupled to the rear drive shaft 82; a second axle, shown rear axle 86, coupled to the rear differential 84; and a second pair of tractive elements, shown as rear tractive elements 88, coupled to the rear axle 86. In some embodiments, the rear tractive assembly 80 includes a plurality of rear axles 86. In some embodiments, the rear tractive assembly 80 does not include the rear drive shaft 82 or the rear differential 84 (e.g., a front-wheel-drive vehicle). In some embodiments, the rear drive shaft 82 is directly coupled to the transmission 56 (e.g., in a rear-wheel-drive vehicle, in embodiments where the driveline 50 does not include the transfer case 58, etc.) or the prime mover 52 (e.g., in a rear-wheel-drive vehicle, in embodiments where the driveline 50 does not include the transfer case 58 or the transmission 56, etc.). The rear axle 86 may include one or more components. According to the exemplary embodiment shown in FIG. 1, the front tractive elements 78 and the rear tractive elements 88 are structured as wheels. In other embodiments, the front tractive elements 78 and the rear tractive elements 88 are otherwise structured (e.g., tracks, etc.). In some embodiments, the front tractive elements 78 and the rear tractive elements 88 are both steerable. In other embodiments, only one of the front tractive elements 78 or the rear tractive elements 88 is steerable. In still other embodiments, both the front tractive elements 78 and the rear tractive elements 88 are fixed and not steerable.

In some embodiments, the driveline 50 includes a plurality of the prime mover 52. By way of example, the driveline 50 may include a first of the prime mover 52 that drives the front tractive assembly 70 and a second of the prime mover 52 that drives the rear tractive assembly 80. By way of another example, the driveline 50 may include a first of the prime mover 52 that drives a first one of the front tractive elements 78, a second of the prime mover 52 that drives a second one of the front tractive elements 78, a third of the prime mover 52 that drives a first one of the rear tractive elements 88, and/or a fourth of the prime mover 52 that drives a second one of the rear tractive elements 88. By way of still another example, the driveline 50 may include a first of the prime mover 52 that drives the front tractive assembly 70, a second of the prime mover 52 that drives a first one of the rear tractive elements 88, and a third of the prime mover 52 that drives a second one of the rear tractive elements 88. By way of yet another example, the driveline 50 may include a first of the prime mover 52 that drives the rear tractive assembly 80, a second of the prime mover 52 that drives a first one of the front tractive elements 78, and a third of the prime mover 52 that drives a second one of the front tractive elements 78. In such embodiments, the driveline 50 may not include the transmission 56 and/or the transfer case 58 or may include multiple of the transmissions 56 and/or the transfer cases 58 (e.g., one of the transmissions 56 and/or one of the transfer cases 58 for each of the prime mover 52, etc.).

As shown in FIG. 3, the driveline 50 includes a power-take-off (“PTO”), shown as PTO 90. While the PTO 90 is shown as being an output of the transmission 56, in other embodiments the PTO 90 may be an output of the prime mover 52, the transmission 56, and/or the transfer case 58. According to an exemplary embodiment, the PTO 90 is configured to facilitate driving an attached implement and/or a trailed implement of the vehicle 10. In some embodiments, the driveline 50 includes a PTO clutch positioned to selectively decouple the driveline 50 from the attached implement and/or the trailed implement of the vehicle 10 (e.g., so that the attached implement and/or the trailed implement is only operated when desired, etc.).

According to an exemplary embodiment, the braking system 100 includes one or more brakes (e.g., disc brakes, drum brakes, in-board brakes, axle brakes, etc.) positioned to facilitate selectively braking (i) one or more components of the driveline 50 and/or (ii) one or more components of a trailed implement. In some embodiments, the one or more brakes include (i) one or more front brakes positioned to facilitate braking one or more components of the front tractive assembly 70 and (ii) one or more rear brakes positioned to facilitate braking one or more components of the rear tractive assembly 80. In some embodiments, the one or more brakes include only the one or more front brakes. In some embodiments, the one or more brakes include only the one or more rear brakes. In some embodiments, the one or more front brakes include two front brakes, one positioned to facilitate braking each of the front tractive elements 78. In some embodiments, the one or more front brakes include at least one front brake positioned to facilitate braking the front axle 76. In some embodiments, the one or more rear brakes include two rear brakes, one positioned to facilitate braking each of the rear tractive elements 88. In some embodiments, the one or more rear brakes include at least one rear brake positioned to facilitate braking the rear axle 86. Accordingly, the braking system 100 may include one or more brakes to facilitate braking the front axle 76, the front tractive elements 78, the rear axle 86, and/or the rear tractive elements 88. In some embodiments, the one or more brakes additionally include one or more trailer brakes of a trailed implement attached to the vehicle 10. The trailer brakes are positioned to facilitate selectively braking one or more axles and/or one more tractive elements (e.g., wheels, etc.) of the trailed implement.

### Debris Shield

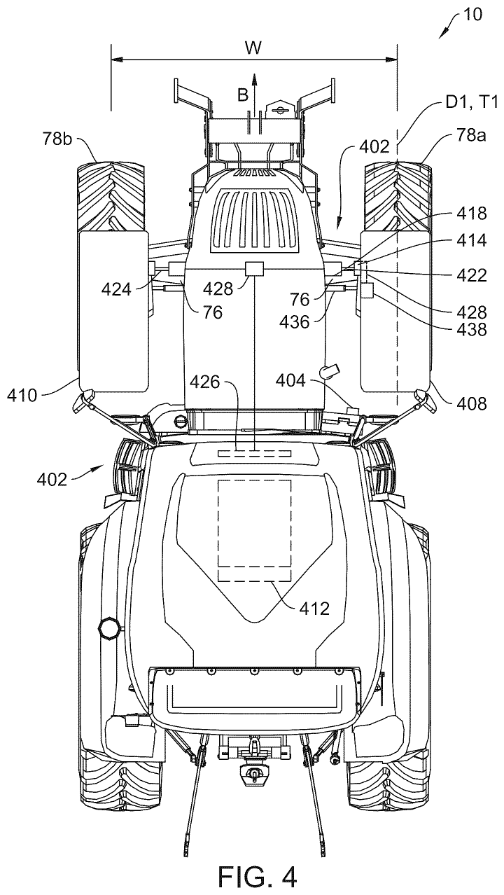

Turning now to FIG. 4, the vehicle 10 may include a fender, mud flap, quarter panel, wheel arch, mudguard, splash shield, wing, apron, body panel, or overfender, shown as first debris shield 408. The first debris shield 408 is adapted to protect the vehicle 10 from damage caused by road debris (e.g., rocks, mud, dirt, snow, ice, salt, sand, branches, concrete, water) that are projected from a wheel of the vehicle. For example, the first debris shield 408 is positioned proximate the rotating tires and between the rotating tires and the vehicle's exterior (e.g., a windshield, wheel well, and/or surrounding body parts) to act as a barrier between the rotating tires and the vehicle's exterior, thereby preventing the road debris from being projected onto a windshield or sensor (thereby obscuring visibility for an operator or an autonomy system sensor 404), onto a body (thereby causing damage, such as chipping paint or scratching parts), or into sensitive mechanical areas (thereby obstructing mechanical processes of the vehicle 10). Additionally or alternatively, the debris shield 408 may help reduce aerodynamic drag. In some embodiments, the first debris shield 408 may provide one or more mounting points for various components and systems (e.g., lights).

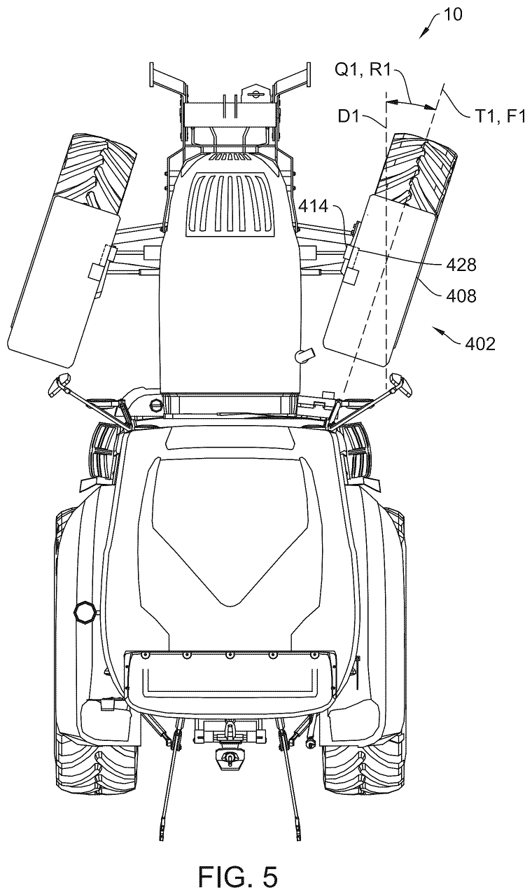

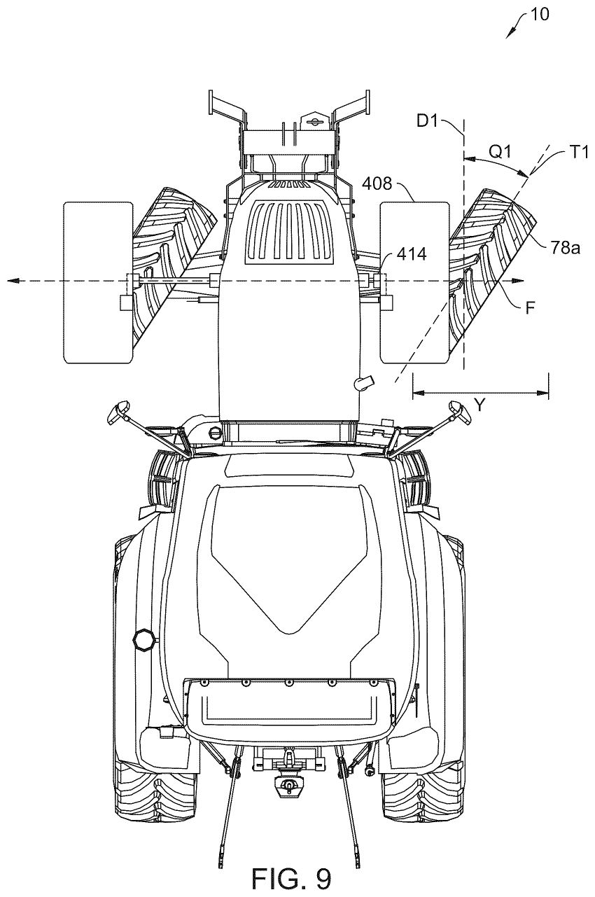

The first debris shield 408 is adapted to actuate based at least in part on a movement of the first tractive element 78a, such as during steering or high/low speeds. The first debris shield 408 may be actuated such that the first debris shield 408 pivots about an articulation point, thereby maintaining a parallel alignment with the first tractive element 78a (e.g., as shown in FIG. 5). In some embodiments, as shown in FIG. 9, an actuator may laterally adjust the position of the first debris shield 408 such that the first debris shield 408 moves along an axis F that extends parallel to the front axle 76 of the vehicle 10. The actuator 414 may laterally adjust the position of the first debris shield 408 (as shown in FIG. 9) in addition to or alternative to pivoting the first debris shield 408 relative to the chassis (e.g., the frame 12) in accordance with the steering of the first tractive element 78a.

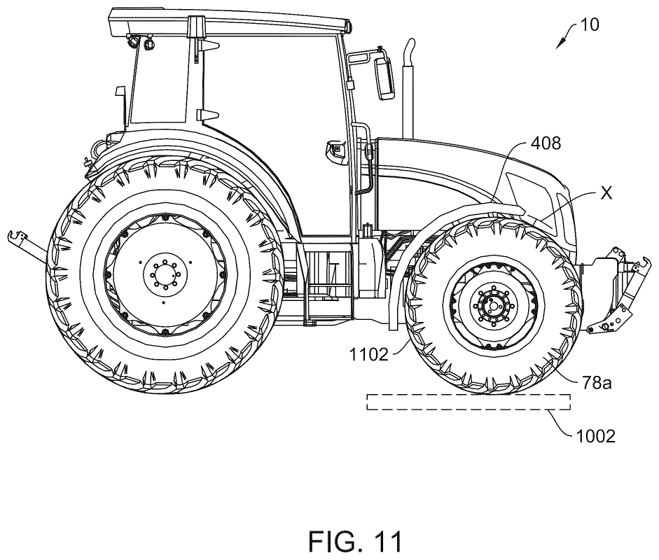

In at least one embodiment, the first debris shield 408 is mounted to the vehicle 10 (e.g., to the frame 12) such that the first debris shield 408 is positioned between a first tractive element 78a and the cab 30. The first debris shield 408 may be mounted to the vehicle 10 (e.g., to the chassis, axle, frame 12, etc.) such that the first debris shield 408 is proximate (e.g., within 2-36 inches) to the first tractive element 78a. For example, the first debris shield 408 may partially extend circumferentially around an outer perimeter of the first tractive element 78a at a distance X from the outer perimeter of the debris shield (as shown in FIG. 11). Distance X may be 0.1-0.5 x a diameter of the first tractive element 78 a. In some embodiments, the distance X is 2-36 inches. In some embodiments, the first debris shield 408 is mounted to the vehicle 10 (e.g., to the frame 12) such that the first debris shield 408 is positioned between the first tractive element 78a and a sensor for autonomous control of the vehicle 10. In some embodiments, the first debris shield 408 is mounted to the frame 12 of the vehicle 10 such that the first debris shield 408 is mechanically decoupled from a steering mechanism that causes steering actuation of the first tractive element 78a, thereby being mechanically decoupled from articulation of the first tractive element 78a. For example, when mechanically decoupled from the steering mechanism of the vehicle 10, the first debris shield 408 is able to actuate (e.g., pivot, laterally adjust, circumferentially rotate, etc.) independently of the steering actuation of the first tractive element 78a. As described in further detail herein, the first debris shield 408 is actuated by an actuator and not by mechanical linkages to the steering mechanism/system.

The vehicle 10 may also include a second tractive element 78b of the front tractive elements 78 described in FIG. 1. The second tractive element 78b is adapted to support the vehicle 10 and/or pivot so as to facilitate steering of the vehicle 10. As with the first tractive element 78a, the second tractive element 78b may be rotatably coupled to the front axle 76. The vehicle 10 may include a second debris shield 410, which may be substantially similar to the first debris shield 408 of the vehicle 10, as described herein.

The vehicle 10 may include a motor, solenoid, hydraulic cylinder, pneumatic cylinder, electro servo, linear actuator, electromechanical actuator, or piezoelectric actuator, shown as actuator 414. The actuator 414 may be adapted to positionally adjust the first debris shield 408 relative to the first tractive element 78a to provide greater ground visibility while and/or maintain protection of the vehicle 10 from debris projected from the rotation of the first tractive element 78a. As used herein, ground visibility refers to an operator's (or autonomy system's) visibility of an area surrounding tractive elements (e.g. first tractive element 78a, the second tractive element 78b, and/or the rear tractive elements 88) when operating the vehicle 10. It should be understood that the term “operator” may also refer to an autonomous and/or semi-autonomous guidance system. For example, ground visibility may refer to an autonomy system's perception (e.g., visual, ultrasound, radar, etc.) of the area surrounding the tractive elements.

The vehicle 10 may include an operator seat 412. The operator seat 412 may be adapted to provide a support surface for an operator of the vehicle 10 to sit/stand during operation of the vehicle 10. Ground visibility may refer to the operator's visibility when positioned on or near the operator seat 412 during operation of the vehicle 10. By utilizing actuated fenders (e.g., the first debris shield 408), smaller fenders are able to be used while maintaining debris protection across a range of steering angles of the first tractive element 78a. Smaller fenders allow for increased ground visibility because the fender is obstructing less of the operator's view when the operator is positioned on the operator seat 412.

The actuator 414 is operatively coupled (e.g., either directly or indirectly) to the first debris shield 408. For example, the first debris shield 408 may include a mount 428 that is configured to interface with the actuator 414 either directly or indirectly. In one embodiment, the actuator 414 is a worm gear and the mount 428 gearedly interfaces with the worm gear (e.g., as a worm wheel or worm shaft) to adjust a position of the first debris shield 408. Additionally or alternatively, the mount 428 may include a shaft coupler that couples to a shaft of the actuator 414. In some embodiments, the mount 428 fastened to an actuated portion of the actuator 414 (e.g., a hydraulic piston).

The actuator 414 may include a hydraulic piston and cylinder operatively coupled to the first debris shield 408. In such embodiments, the actuator 414 includes a cylinder barrel, piston, piston rod, seals, and ports. When pressurized fluid from a hydraulic system of the vehicle 10 is pumped into one side of the cylinder through an inlet port, it acts on the surface of the piston, generating force. This force pushes the piston along the barrel, resulting in the extension or retraction of the piston rod depending on the direction of fluid flow. The piston is coupled to the first debris shield 408 at the mount 428, thus causing the first debris shield 408 to adjust in position.

The actuator 414 may be an electromechanical motor. In such embodiments, rotational movement of the electromechanical motor may be transferred to the first debris shield 408 to adjust its position and/or orientation. For example, in one embodiment, the rotational movement is transferred to the first debris shield 408 as rotational movement, causing the first debris shield 408 to pivot about an axis (e.g., an axis extending upwardly from the ground) such that it pivots in accordance with a steering pivot of the first tractive element 78a. In some embodiments, the rotational movement of the electromechanical motor is converted to linear movement through gearing such that the first debris shield 408 is laterally adjusted along the axis F (as shown in FIG. 9). Such gearing may be integrated into the mount 428 or separate therefrom.

The actuator 414 may be coupled to the vehicle 10 directly or directly at a mount 418. In some embodiments, the actuator 414 is coupled to the mount 418 by a connecting member 422. The mount 418 may be coupled to the vehicle 10 at the front axle 76. In some embodiments, the mount 418 is coupled to the vehicle 10 at the frame 12. In various embodiments, the mount 418 is coupled to the vehicle 10 such that it is mechanically decoupled from the steering system of the 10 and the first debris shield 408 is not directly, mechanically actuated by movement of the steering system. The mount 418 may also provide a mounting location for the first debris shield 408 such that the first debris shield 408 is coupled to the vehicle 10 through the mount 418. The actuator 414 may couple the first debris shield 408 to the mount 418 such that the first debris shield 408 is positioned at least partially circumferentially around the first tractive element 78a such that it is positioned between the cab 3f0 and the first tractive element 78a, thus protecting the operator's visibility by protecting the cab 30 windshield between the operator seat 412 and the first tractive element 78a. Further, the actuator 414 is adapted to actuate the first debris shield 408 such that it maintains a relative position between the operator seat 412 and the first tractive element 78a during a range of steering angles, as described further herein. It should be understood that the first debris shield 408 is configured to protect the vehicle 10 and surrounding areas from debris projected along a tractive element axis T1. Thus, the actuator 414 is configured to adjust the first debris shield 408 from a first debris shield first position to a first debris shield second position such that at least a portion of the first debris shield 408 is maintained along the tractive element axis T1.

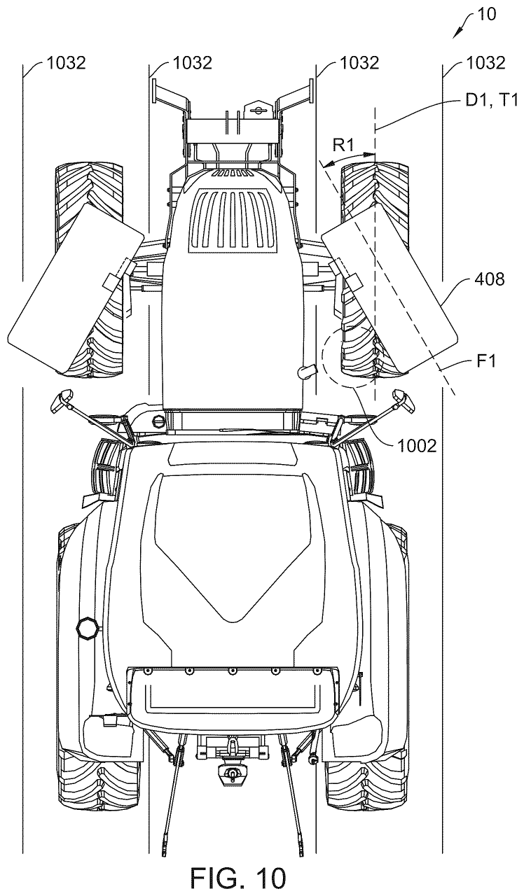

The first tractive element 78a and the second tractive element 78b may be separated by a distance or tread spacing, shown as distance W (e.g., 60 in, 76 in, 88 in, etc.). In some embodiments, the vehicle 10 is an agricultural vehicle that travels between crop rows (e.g., crop rows 1032 as shown in FIG. 10). The distance W may be such that the vehicle 10 is able to traverse a field of crop rows 1032 without traveling over the crop rows 1032. In at least one implementation of the methods and systems described herein, the actuator 414 may be configured to adjust the first debris shield 408 out of alignment with the tractive element axis T1 for an operator of the vehicle 10 to have greater visibility of the contact area 1002 between the ground and the first tractive element 78a. In this way, the operator is able to more clearly view the point of contact between the first tractive element 78a and the ground near the crop rows 1032, allowing for more precision steering, such as at low speeds. As described further herein, the distance W may be stored in a computer-readable storage medium that is accessible to a control logic of the vehicle 10 and used to determine a desired position to which to adjust the first tractive element 78a and/or a maximum positional limit of the first tractive element 78a.

It should be understood that the methods and systems described herein with regard to the first tractive element 78a, the first debris shield 408, the mount 428, the actuator 414, the connecting member 422, and/or the mount 418 may be applied to the other tractive elements of the vehicle 10, such as the second tractive element 78b and/or the rear tractive elements 88.

### Control System

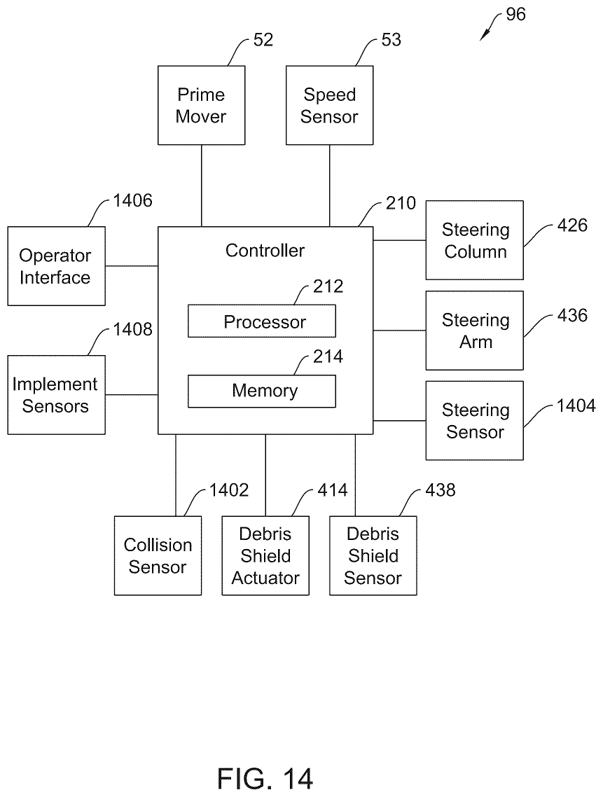

Referring to FIG. 14, the control system 96 is shown according to an exemplary embodiment. The control system 96 may facilitate the operation of a debris shield system 402 as described herein, the debris shield system 402 including one or more of the first tractive element 78a, the first debris shield 408, the mount 428, the actuator 414, the connecting member 422, and/or the mount 418. The control system 96 includes processing circuitry, shown as a controller 210. The controller 210 includes a processor 212 and a memory device, shown as memory 214. The processor 212 may be configured to execute one or more instructions stored on the memory 214 (e.g., computer-readable, non-transitory storage medium) to perform one or more of the methods and processes described herein, such as the actuation of the debris shield 408. The memory 214 may include a computer-readable, non-transitory storage medium containing the one or more instructions that when executed by the processor 212 causes to the processor 212 to perform one or more of the methods and steps described herein. The controller 210 may be configured to receive information from one or more devices (e.g., sensors, user interfaces, etc.) and/or to provide information (e.g., notifications, commands, etc.) to one or more devices (e.g., actuators, user interfaces, etc.).

The controller 210 is operably coupled to the other devices of the control system 96. By way of example, the controller 210 may include a communication interface to facilitate communication with the other devices. In some embodiments, the devices of the control system 96 utilize wired communication (e.g., Ethernet, USB, serial, etc.). In some embodiments, the devices of the control system 96 utilize wireless communication (e.g., Bluetooth, Wi-Fi, Zigbee, cellular communication, satellite communication, etc.). The devices of the control system 96 may communicate over a network (e.g., a local area network, a wide area network, the Internet, a CAN bus, etc.).

As shown in FIG. 14, the controller 210 is operatively coupled to the prime mover 52. The controller 210 may provide commands to the prime mover 52. By way of example, the controller 210 may control the rotational speed of the prime mover 52. In one such example, the prime mover 52 is an engine, and the controller 210 provides commands that control a rotational speed of the engine.

In some embodiments, the control system 96 further includes a sensor, shown as speed sensor 53, that is operatively coupled to the controller 210. The speed sensor 53 may provide speed data indicating a rotational speed of the prime mover 52 and/or the front tractive element 78a or the rear tractive elements 88. For example, the speed sensor 53 may transmit speed data in a data packet to the controller 210. The speed data may include a current speed of the vehicle 10. The controller 210 may utilize the speed data in a feedback loop to control the rotational speed of the prime mover 52. In some embodiments, the controller 210 may utilize the current speed transmitted in the speed data to determine a desired position for the first debris shield 408.

As shown in FIG. 14, the controller 210 is operatively coupled to the actuator 414 and/or the debris shield position sensor 438. The controller 210 may provide commands to the actuator 414. By way of example, the controller 210 may control the actuator 414 to move the first debris shield 408 relative to the frame 12 and/or the first tractive element 78a from a first debris shield first position to a first debris shield second position. The controller 210 may receive information from the debris shield position sensor 438. By way of example, the controller 210 may receive position data from the debris shield position sensor 438 indicating the position of the debris shield 408 relative to the frame 12 and/or the first tractive element 78a. This position data may include a lateral position of the first tractive element 78a relative to the frame 12 and/or the first tractive element 78a (e.g., relative to the first tractive element axis T1) and/or a rotational position relative to the frame 12 and/or the first tractive element 78a. The controller 210 may utilize the position data in a feedback loop to control the position of the debris shield 408 by transmitting control signals to the actuator 414.

In some embodiments, the control system 96 includes one or more input devices, output devices, user interfaces, or operator interfaces, shown as operator interfaces 1406. The operator interfaces 1406 may be built into the vehicle 10 (e.g., positioned within the cab 30, positioned along the exterior of the vehicle 10, etc.). Alternatively, the operator interfaces 1406 may be portable and/or separable from the vehicle 10. For example, the operator interfaces 1406 may include one or more user devices, such as smartphones, tables, laptops, desktops, pagers, or other user devices. The operator interfaces 1406 may include one or more input devices configured to receive inputs (e.g., commands) from an operator to facilitate operator control over the vehicle 10. By way of example, the operator interfaces 1406 may include touch screens, buttons, steering wheels, pedals, levers, switches, knobs, keyboards, mice, microphones, and/or other input devices. The operator interfaces 1406 may include one or more output devices configured to provide information to an operator (e.g., notifications, operating conditions, etc.). By way of example, the operator interfaces 1406 may include screens, lights, speakers, haptic feedback devices, and/or other output devices.

In some embodiments, the control system 96 includes one or more sensors, shown as implement sensor 1408, that are operatively coupled to the controller 210. The implement sensor 1408 may be configured to provide front implement data indicating what type of an implement 190 is coupled to the frame 12 and/or implement positional data indicating a position of the implement 190 (e.g., raised, lowered, pivoted, extended, contracted, etc.). By way of example, the implement sensor 1408 may provide a serial number or identification number that identifies the implement 190. A list correlating the identification number to various aspects of the implement 190 (e.g., compatibility with the vehicle 10, size, weight, attachment location on the frame 12, etc.) may be predetermined and stored in the memory 214. In some embodiments, the implement sensor 1408 are configured to recognize, read, or otherwise interact with an identifier on the implement 190. By way of example, the implement 190 may include a QR code, a bar code, an RFID tag, or an NFC tag positioned to be read by a corresponding scanner of the implement sensor 1408. The implement sensor 1408 may be positioned to interact with the identifier when the implement 190 is coupled to the frame 12. The implement 190 may be any number of front implements including a mower, forks, snowplow, harvester, etc.

### Debris Shield Actuation

During operation of the vehicle 10, the first tractive element 78a rotates to locomote the vehicle 10. During rotation of the first tractive element 78a, debris from the ground is aerially projected by the first tractive element 78a along the first tractive element axis T1. During forward movement of the 10, the debris is aerially projected toward the frame 12, such as at the cab 30. The aerial projection of the debris is substantially related to the position and angle of the first tractive element 78a. By way of example, when the first tractive element 78a is positioned along the axis D1 (e.g., the first tractive element axis T1 is colinear or parallel with the axis D1), the debris is substantially projected parallel to the default axis D in the direction opposite the movement of the vehicle 10 (e.g., when the vehicle 10 is traveling forward, the debris is projected rearward along the first tractive element axis T1). Likewise, as shown in FIG. 5, when the first tractive element 78a is steered to the angle Q1 from the axis D1 (e.g., the first tractive element axis T1 is rotated to the steered angle Q1 from the axis D1) the debris is projected substantially parallel to the front tractive element axis T1.

This relationship between the steered angle Q1 of the first tractive element 78a and the debris projection results in a range of debris projection angles. The range of debris projection may span a range of angles corresponding to the extreme steering angles of the vehicle 10 (e.g., 45° on either side of forward). Fenders, such as the debris shield 408, are used to protect the vehicle 10 and its surroundings from the projectile debris caused by the rotation of the first tractive element 78a. To minimize the size of the first debris shield 408 that is required to protect the range of projection, the first debris shield 408 may be actuated to move relative to the frame 12 and correspond to the steered movement of the first tractive element 78a. The control system 96 (as shown in FIG. 14) may be used to control the actuator 414, and by extension, the first debris shield 408, such that the first debris shield 408 is moved relative to frame 12 and corresponds to the steered movement of the first tractive element 78a such that at least a portion of the first debris shield 408 is maintained between in line with the first tractive element axis T1.

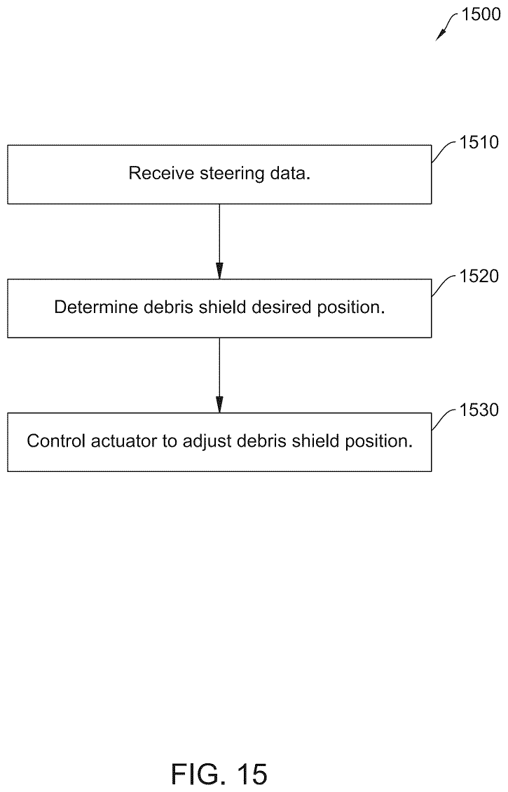

Referring to FIG. 15, a method 1500 of operating the vehicle 10 is shown according to an embodiment. The method 1500 utilizes the debris shield system 402 to manipulate the position and/or orientation of the first debris shield 408, thereby protecting the vehicle 10 and surrounding areas from projectile debris from the first tractive element 78a. For example, as shown in FIG. 5, as the first tractive element 78a is steered 30° to the right, the debris shield system 402 may cause the first debris shield 408 to be rotated 30° to the right to maintain an alignment relative to the first tractive element 78a. In some embodiments, as shown in FIG. 9, as the first tractive element 78a is steered 30° to the left, the debris shield system 402 may cause the first debris shield 408 to be laterally adjusted to the left to maintain alignment with the first tractive element axis T1.

At step 1510 of the method 1500, steering data of the vehicle 10 is received by the controller 210. The steering data includes a steering angle Q1 of the tractive element 78a of the vehicle 10. One or more sensors (e.g., a steering sensor 1404) coupled to and/or integrated into a steering subsystem of the vehicle 10 provide the steering data to the controller 210. The controller 210 receives the steering data through wired or wireless communication. The steering data may include the steering angle Q1 directly or may be used to indirectly determine the steering angle Q1. For example, the steering sensor 1404 may be coupled to the steering column to measure a position of the steering column 426 (as shown in FIG. 4) during steering. The steering column 426 position may be passed to the controller 210, thereby providing the controller 210 with the steering angle Q1 indirectly. By way of example, the steering angle Q1 is provided to the controller 210 indirectly because the controller 210 may use this data to determine the steering angle Q1 based at least in part on the steering column position. For example, the steering column position may be mapped to a steering angle Q1. This mapping may be stored in computer-readable, non-transitory storage of the memory 214 and accessed by the processor 212 such that the controller 210 may associate the received steering column position to a known steering angle Q1 associated with the received steering column position. This mapping may occur in both steer-by-wire implementations (e.g., implementations in which the steering column provides a signal to the controller 210 which in turn actuates the wheels through an actuator) or by direct steering implementations (e.g., implementations in which the steering column is mechanically coupled to the first tractive element 78a such that the physical movement of the steering column is mechanically transferred to steering of the first tractive element 78a). It should be understood that while the steering column 426 is described above, any part or portion of the steering system (e.g., steering wheel, steering column, electronic steering controls/instructions from the controller, etc.) may be measured by the steering sensor 1404.

Alternative embodiments exist in which the controller 210 receives steering data from one or more steering sensors 1404. For example, the steering sensor 1404 may be coupled to a steering arm, shown as steering arm 436 in FIG. 4. The steering arm 436 may be mechanical linkage in the steering system (e.g., a tie rod) or an actuator to facilitate steering (e.g., a hydraulic piston system coupled to the first tractive element 78a). Similar to the mapping between the steering column and the steering angle Q1, a mapping may be made between the positions of the steering arm 436 and the steering angle of the first tractive element 78a. The steering sensor 1404 may measure a position of the steering arm 436 (e.g., using proximity sensors, limit switches, potentiometers, reed switches, etc.) and transmit the measured position of the steering arm 436 to the controller 210. As described above, a mapping of a position of the steering arm 436 (e.g., mechanical linkage or actuator) to the steering angle Q1 may be stored in the memory 214 and accessed by the processor 212 to dynamically map the received position of the steering arm 436 to a current steering angle Q1.

The steering arm 436 is operatively coupled to the first tractive element 78a such that movement of the steering arm 436 is indicative of steered movement of the first tractive element 78a. In some embodiments, such as when the steering arm 436 is a mechanical linkage, the steering arm 436 is adjusted in position in response to the first tractive element 78a moving. In other embodiments, such as when the steering arm 436 is an actuator, the steering arm 436 causes steering of the first tractive element 78a. In either case, movement of the steering arm 436 is indicative of movement of the first tractive element 78a.

As shown in FIG. 14, the controller 210 is operatively coupled to the steering arm 436. In at least one embodiment, the steering arm 436 is an actuator, such as a hydraulic piston and cylinder. The controller 210 is operatively coupled to the steering arm 436 such that the controller 210 may transmit instructions to the steering arm 436 to cause an actuation of the steering arm 436 and thereby adjust the steering angle of the first tractive element 78a. The controller 210 receives a request to adjust the steering angle Q1 to a desired steering angle. The request is received from the steering column 426. The controller 210 generates and transmits a control signal to the steering column 426 to actuate and cause the first tractive element 78 a to turn to the desired steering angle. In some embodiments, a feedback loop between the controller 210, the steering column 426, and/or the steering sensor 1404 is used to determine and control the steering angle Q1.

In some embodiments, the controller 210 receives speed data in addition to the steering data. The controller 210 receives the speed data from the speed sensor 53, as described in FIG. 14. The speed sensor 53 may provide speed data indicating a rotational speed of the prime mover 52 and/or the first tractive element 78a. The controller may determine a speed of the vehicle 10 based on the received speed data. For example, the controller 210 may convert the rotational speed of the first tractive element 78a to linear speed of the vehicle 10 based on a circumference of the first tractive element 78a. Likewise, the controller 210 may determine the linear speed of the vehicle 10 based on the rotational speed of the prime mover 52 and a current gear engagement.

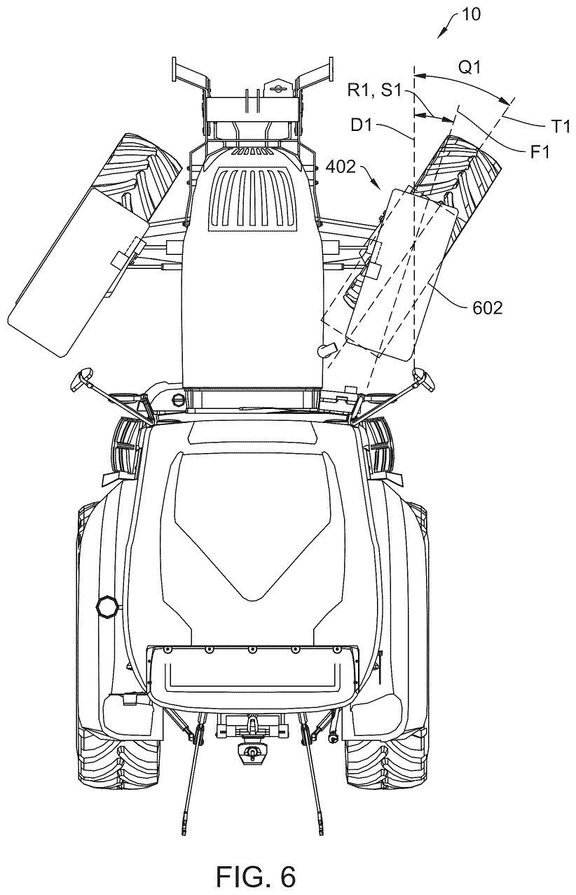

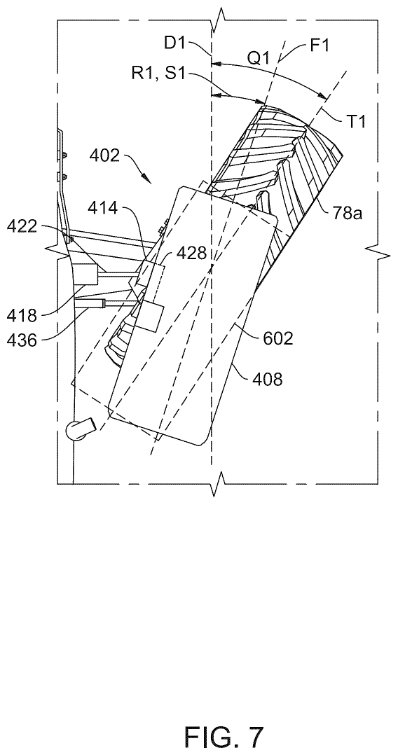

Upon receiving the steering angle Q1 at the controller 210, a desired debris shield position is determined at step 1520 of the method 1500. The desired debris shield position is determined based at least in part on the received or determined steering angle Q1 of the tractive element of the vehicle. In some embodiments, the desired debris shield position is determined by the controller 210. The debris shield position may be defined by the debris shield angle R1 (as shown in FIG. 5), which is a measure of a debris shield axis F1 from the axis D1. In some embodiments, the steering angle Q1 and the debris shield angle R1 are maintained in an aligned orientation (e.g., parallel and/or collinear), as shown in FIG. 5. However, as described in greater detail herein, the steering angle Q1 and the debris shield angle R1 need not be aligned, such as when the first debris shield 408 is adjusted laterally (as shown in FIG. 9) and/or when the first debris shield 408 reaches a positional limit (as shown in FIGS. 6-7).

As shown in FIG. 14, the controller 210 is operatively coupled to a debris shield position sensor 438. The debris shield position sensor 438 measures a position of the first debris shield 408 (e.g., relative to the frame 12, the first tractive element 78a, the axis D, etc.). The debris shield position sensor 438 may be a position sensor or encoder integrated into the debris shield system 402 (e.g., on the actuator 414 or a pivoting mechanism). For example, a rotary encoder coupled to a pivot axis of the first debris shield 408, which tracks its angular position by measuring the rotation as the first debris shield 408 pivots, may be used to determine the position (e.g., debris shield angle R1) of the first debris shield 408. Alternatively or additionally, the debris shield position sensor 438 may be a linear position sensor, such as a potentiometer or a linear variable differential transformer (LVDT), and can be used if the motion of the first debris shield 408 involves a sliding or extending mechanism rather than pure rotation (such as shown in FIG. 9).

Once the position of the debris shield (e.g., the debris shield angle R1 or a lateral position of the first tractive element axis T1 from the axis D1) is determined, the first debris shield position is compared to the steering angle Q1 to determine a first debris shield desired position. In some embodiments, the first debris shield desired position is defined by a debris shield angle R1 (as measured from the axis D1), which has a desired position that is aligned with the steering angle Q1, so as to facilitate shielding of projectile debris from the first tractive element 78a. As such, the controller 210 dynamically monitors both the steering angle Q1 and the debris shield angle R1 and dynamically updates the first debris shield desired position/angle in response to the debris shield angle R1 falling outside a threshold of the steering angle Q1. By way of example, if the debris shield angle R1 is outside of 5° on either side of the steering angle Q1, the controller 210 transmits instructions to the actuator 414 to adjust the first debris shield 408 until the first debris shield angle R1 is within the threshold (e.g., +/−5°) of the steering angle Q1. As described above, a feedback loop between the debris shield position sensor 438, the actuator 414, and/or the controller 210 may be employed to maintain the debris shield angle R1 within the threshold of the steering angle Q1. It should be understood that the threshold may be any range suitable to the embodiments described herein (e.g., +/−1°, 5°, 10°, etc.).

In embodiments in which the first debris shield 408 is actuated laterally, such as illustrated in FIG. 9, a debris shield position, as opposed to the debris shield angle R1, is monitored by the debris shield position sensor 438. In like manner as described above, the controller 210 receives the first debris shield first position from the debris shield position sensor 438 and determines a first debris shield desired position based in part on the steering angle Q1, as measured by the steering sensor 1404. The first debris shield desired position may be mapped to steering angles Q1 and stored (e.g., as a look-up table) within the computer-readable, non-transitory storage medium of the memory 214. The processor 212 may access this mapping to facilitate making a determination of the first debris shield desired position. For example, the processor 212 may use the look-up table to search the steering angle Q1 and retrieve an associated first debris shield desired position/angle.

At step 1530 of the method 1500, the controller 210 controls the actuator 414 to adjust the first debris shield 408 from a first debris shield first position to a first debris shield second position, in which the first debris shield second position is the determined first debris shield desired position. As illustrated in FIG. 9, as the tractive element axis T1 of the first tractive element 78a turns to a steering angle R1 from the axis D1, the first debris shield 408 is shifted (through actuation of the actuator 414) from the first debris shield first position (e.g., a neutral, center position as shown in FIG. 4) to a first debris shield second position (e.g., a first debris shield desired position). As shown in FIG. 9, the first debris shield desired position may be shifted along the axis F which, in some embodiments, is parallel to the front axle 76. The first debris shield 408 may have a range of distance Y, which may span the steering range of the first tractive element 78a. For example, the distance Y may span a distance such that the first debris shield 408 is maintained in a position proximate to the first tractive element 78a to shield projectile debris from the first tractive element 78a. In some embodiments, the first debris shield 408 is maintained in a position along the tractive element axis T1 such that projectile debris from the first tractive element 78a is shielded by the first debris shield 408, as shown in FIG. 9.

Once the first debris shield desired position is determined by the controller 210, the controller 210 transmits an instruction(s) to the actuator 414 to actuate such that the first debris shield 408 is moved to the first debris shield desired position. As described above, the debris shield position sensor 438 may dynamically transmit to the controller 210 the current position/angle of the first debris shield 408 such that the controller 210 may dynamically adjust the instructions to the actuator 414 in response to the changed position of the first debris shield 408 and/or the changed angle of the steering angle Q1.

While generally the first debris shield 408 is controlled by the controller 210 such that is protects against projectile debris from the first tractive element 78a, an additional benefit of one or more embodiments of the methods and systems described herein relate to the ability of the controller 210 to set the first debris shield desired position independent or disassociated from the steering angle Q1 of the vehicle 10. For example, in some instances, an operator of the vehicle 10 may want to increase visibility of the contact area 1002, as shown in FIG. 10. In such embodiments, the first debris shield desired position may be such that the debris shield axis F1 is misaligned with the tractive element axis T1, thus providing greater overhead visibility to the contact area 1002, is illustrated in FIG. 10. However, it should be understood that alternative embodiments may be used to adjust the first debris shield position such that the first debris shield 408 is not aligned with the tractive element axis T1. For example, in embodiments in which the first debris shield 408 is actuated laterally (as shown in FIG. 9), the controller 210 may transmit instructions to control the actuator 414 such that the first debris shield 408 is adjusted laterally out of alignment with the first tractive element 78a, thus providing greater visibility of the contact area 1002. Such embodiments may be implemented when the vehicle 10 is operating in a visibility mode.

The visibility mode may be triggered by various inputs and/or conditions. For example, the operator interface 40 may transmit a request to enter the visibility mode in response to a selection from the operator. The request is transmitted from the operator interface 40 to the controller 210 and, in response, the controller 210 adjusts an operating mode. Different operating modes may have different look-up tables for mapping the steering angle Q1 to first debris shield desired positions/angles.

In another embodiment, the visibility mode may be triggered by the vehicle traveling at a current speed below a speed threshold (e.g., 1 mph, 5 mph, etc.). In such embodiments, the controller 210 receives speed data from the speed sensor 53 and determines a current speed of the vehicle 10. The controller 210 compares the current speed of the vehicle 10 against the speed threshold. Upon the current speed not satisfying (e.g., falling below) the speed threshold, the controller 210 transmits instructions to the actuator 414 to adjust the first debris shield 408 from the first debris shield position (e.g., aligned with the tractive element axis T1) to a third debris shield position (e.g., misaligned with the first tractive element 78a or tractive element axis T1 to increase visibility of the contact area 1002). In some embodiments, the visibility mode includes the speed threshold. By way of example, the vehicle will only misalign the first debris shield 408 to the first debris shield third position in response to the current speed of the vehicle 10 failing to satisfy the speed threshold if the vehicle 10 is already operating in the visibility mode, as requested by the operator through the operator interface 40. In other embodiments, the visibility mode is automatically triggered by the current speed falling below the speed threshold.

The visibility mode may be beneficial at low speeds for a variety of reasons. For example, delicate maneuvering (e.g., between crop rows 1032) of the vehicle 10 often occurs at low speeds. This delicate maneuvering is facilitated by increased visibility of the contact area 1002 between the first tractive element 78a and the ground. For example, the operator is able to ensure the vehicle 10 is not traveling on the crop rows 1032. Additionally, at low speeds debris is not projected with the same velocity as at high speeds. Thus, visibility may have a higher priority to the operator than debris shielding at low speeds.

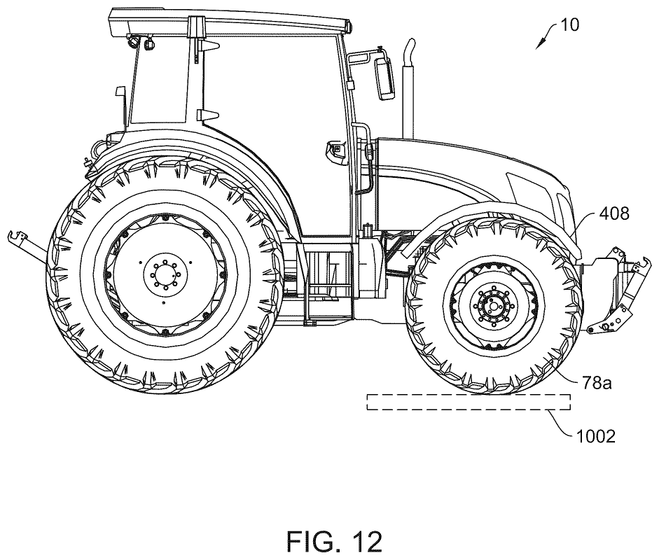

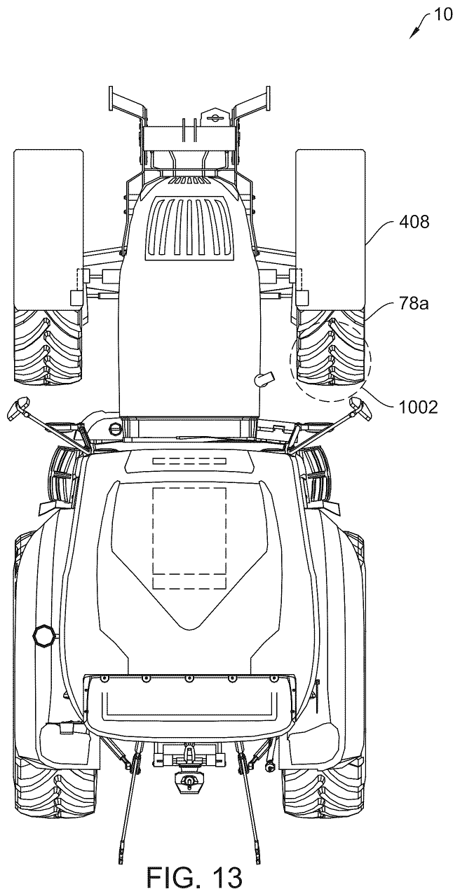

In some embodiments, as shown in FIGS. 11 and 12, the first debris shield 408 may additionally or alternatively actuate circumferentially about the outer perimeter 1102 of the first tractive element 78a. As shown in FIG. 11, the first debris shield 408 is in the first debris shield first position. In FIG. 12, the first debris shield 408 has been actuated circumferentially to the first debris shield third position, thereby increase visibility of the contact area 1002. As described above, the circumferential actuation of the first debris shield 408 may be triggered by entering the visibility mode and/or the current speed of the vehicle 10 not satisfying the speed threshold. FIG. 13 illustrates the vehicle of FIG. 12 in a top view with the first debris shield 408 circumferentially rotated to provide greater visibility of the contact area 1002.

It is understood that other implementations and embodiments exist in which the first debris shield desired position is not aligned with the tractive element axis T1. For example, as shown in FIG. 6, the first debris shield 408 may have one or more position limits (e.g., a first debris shield limit S1) that restrict the movement of the first debris shield 408. The first debris shield limit S1 may define the maximum position (e.g., the angle that the first debris shield 408 may move from the first debris shield first position, as illustrated in FIG. 4). The first debris shield limit may be implemented, in some embodiments, to avoid a collision between the first debris shield 408 and the vehicle 10 (e.g., the frame 12).

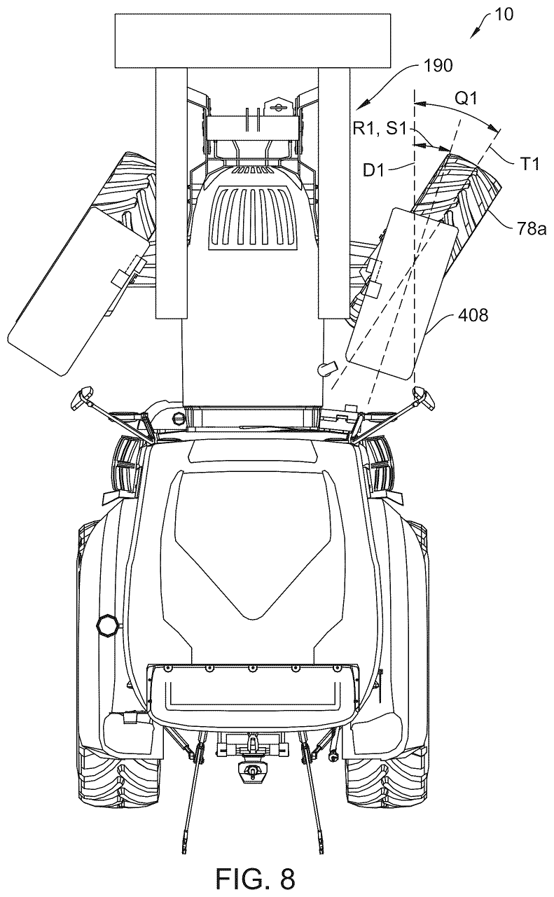

As shown in FIGS. 6, 7, and 8, the actuator 414 may adjust the debris shield 408 to a first debris shield second position that is misaligned with the tractive element axis T1 (e.g., the debris shield axis F1 is misaligned with the tractive element axis T1). In other words, the first debris shield 408 is maintained in a static position relative to frame 12 as the first tractive element 78a continues steering to the steering angle Q1 (as shown in FIGS. 6-8). As illustrated in FIG. 6, the first debris shield 408 is positionally maintained at the first debris shield limit S1, thus avoiding a collision with the frame 12 of the vehicle 10. The dashed box 602 represents the position of the first debris shield 408 without the first debris shield limit S1, illustrating a potential collision between the first debris shield 408 and the frame 12 or other portion of the vehicle 10, such as a fuel tank, the implement 190 (as shown in FIG. 8), cooling package, etc.

Implementation of the first debris shield limit S1 may be executed by the control system 96 working in conjunction with the debris shield system 402. For example, the first debris shield limit S1 may be set based at least on an association between a threshold steering angle relative to a neutral position in which the front tractive element 78a is bearing forward (e.g., when the tire axis is aligned with the axis D1).

The first debris shield limit may be set by manual input by an operator. For example, the operator may steer the first tractive element 78a with the first debris shield 408 remaining in alignment with the tractive element axis T1 (e.g., the debris shield axis F1 in alignment with tractive element axis T1 and/or a portion of the first debris shield 408 in alignment with the tractive element axis T1 such as shown in in FIG. 9). Once the first debris shield 408 reaches a point at which the operator desires the first debris shield limit S1 to be, the operator may provide an indication of such through the operator interface 40. The indication of the first debris shield limit (and the current position/angle of the first debris shield 408) is transmitted to the controller 210 and set/stored (e.g., in the memory 214) as the first debris shield limit. The first debris shield limit may be associated with the current steering angle, the association of which may also be set/stored as a threshold steering angle (e.g., in a look-up table corresponding the steering angle Q1 to desired positions of the first debris shield 408 and/or a first debris shield limit S1). In some embodiments, the first debris shield limit S1 is not associated with a steering angle Q1. For example, in positionally controlling the first debris shield 408 by the actuator 414, the controller may continue transmit to dynamically adjust the position of the first debris shield 408 to maintain the first debris shield 408 in alignment with the first tractive element 78a as long as the otherwise desired position of the first debris shield does not go beyond the first debris shield limit S1, regardless of the steering angle Q1.

The first debris shield limit S1 (and the optionally associated threshold steering angle) may be used by the controller 210 during determination of the first debris shield desired position, such that the first debris shield desired position (e.g., the debris shield angle R1) does not exceed the first debris shield limit S1. Additionally or alternatively, the first debris shield limit S1 may be set and stored in the memory 214 prior to operation by the operator, such as during manufacturing, assembly, etc. The first debris shield limit S1 may be set in accordance with a tread setting (e.g., distance W—as shown in FIG. 4—between the first tractive element 78a and the second tractive element 78b). In at least one example, a vehicle 10 with a tread setting with a larger distance W may have a less restrictive first debris shield limit S1 (e.g., maintains alignment with the first tractive element 78a over a larger range of steering angles) than a smaller distance W. The tread setting may be stored in the memory 214 during assembly of the vehicle 10 and/or by the operator through an interaction with the operator interface 40. A look-up table and/or other association between the tread setting distance W and the first debris shield limit S1 may be stored in the memory 214 such that the debris shield limit S1 to employ for the vehicle 10 may be set through an input to the controller of the actual tread setting distance W of the vehicle 10.

As shown in FIGS. 6 and 7, during operation, the controller 210 may receive an indication of a current steering angle Q1 from the steering sensor 1404. Based on the received indication of the current steering angle, the controller 210 dynamically updates the first debris shield desired position and transmits instructions to the actuator 414 to dynamically adjust the first debris shield 408 in accordance with the updated first debris shield desired position such that alignment of the first debris shield 408 and the first tractive element 78a (either pivotally or laterally) is maintained. Upon receiving an indication that the current steering angle is at the threshold steering angle S1, the controller 210 stops dynamically changing the first debris shield desired position (or otherwise maintains the first debris shield desired position) and maintains the first debris shield 408 at the first debris shield limit S1 as the first tractive element 78a continues steering past the threshold steering angle. Thus, as the current steering angle travels beyond the steering angle threshold, the first debris shield 408 is maintained at the first debris shield limit S1. It is noted that the second debris shield 410 may have a unique limit (e.g., a second debris shield limit) which may or may not correspond to the first debris shield limit S1.

In some embodiments, the first debris shield desired position may be determined based, at least in part, on a front implement position of the implement 190. For example, the controller 210 may compare the front implement position of the implement 190 with the first debris shield first position. The controller 210 may then determine the first debris shield desired position that maintains the first debris shield 408 in alignment with the first tractive element 78a without colliding into another portion of the vehicle 10 (e.g., the implement 190, the frame 12, the first tractive element 78a, etc.) based at least in part on the steering angle Q1 and the front implement position. Upon determining the first debris shield desired position, the controller 210 transmits instructions to the actuator 414 to adjust the first debris shield 408 from the first debris shield first position to the first debris shield second position, wherein the first debris shield second position is the first debris shield desired position.

As shown in FIGS. 6 and 8, the first debris shield 408 and the second debris shield 410 may be actuated independently of each other such that one may be maintained at a debris shield limit while the other continues being actuated by an actuator controlled by the controller 210. This may occur due to a geometry of the frame 12. For example, in a right-hand turn (as shown in FIG. 6), the first debris shield 408 may collide with the frame 12 at the smaller steering angle Q1 than the second debris shield 410. Thus, the first debris shield 408 must have a more limited range of motion in a right-hand turn orientation than the second debris shield 410. Likewise, in a left-hand turn orientation, the second debris shield 410 may have a more limited range of motion and have a limit that stops movement of the second debris shield 410 prior to the first debris shield 408 needing to be limited. Thus, in a right-hand turn as the vehicle 10 is steered at a steering angle Q1, the controller 210 may transmit instructions to both the actuator 414 and the actuator 424 to adjust the first debris shield 408 from a first debris shield first position to a first debris shield second position and the second debris shield 410 from a second debris shield first position to a second debris shield second position, respectively, until the first debris shield 408 reaches the first debris shield limit S1 (and/or that the steering angle Q1 reaches the steering angle threshold), at which point the controller 210 (i) transmits instructions to stop adjusting the first debris shield 408 past the first debris shield limit and (ii) transmits instructions to the continue adjusting the second debris shield 410 to a second debris shield third position. In some embodiments, the controller 210 continues to dynamically control the position of the second debris shield 410 (e.g., in the right-hand turn) until the second debris shield 410 arrives at a second debris shield limit (or the steering angle Q1 arrives at a second threshold steering angle), at which point the controller 210 transmits instructions to the actuator 424 to stop adjusting the second debris shield 410 position (e.g., either laterally or pivotally).

As described above, in some embodiments the vehicle includes the implement 190. In such embodiments, the controller 210 may set the first debris shield limit S1 based at least in part on the implement 190 (e.g., the type of implement, the position of the implement 190, the orientation of the implement 190, an operating mode of the implement, etc.). For example, the controller 210 may receive front implement data including a front implement position of the implement 190 (as described herein). The controller 210 compares the front implement position to the first debris shield position

In some embodiments, the methods and systems described herein may provide for collision detection and mitigation. For example, the controller 210 may be configured to receive an indication of a collision between the first debris shield 408 and another object (e.g., the chassis, the frame 12, the first tractive element 78a, external object to the vehicle 10, the implement 190, etc.). The indication of the collision may come from one or more sensors, such as a collision sensor 1402. The collision sensor may be configured to sense/measure a collision of the first debris shield 408 (or component coupled thereto, such as the mount 428, the connecting member 422 the actuator 414, etc.). The collision sensor 1402 may be configured to detect physical impact, sudden deceleration, or proximity to other objects. For example, the collision sensor 1402 may be an accelerometer to measure rapid changes in speed or direction. The collision sensor 1402 may be or include a gyroscope to supplement an accelerometer by detecting changes in orientation of the first debris shield 408 relative to a known object, such as the frame 12. The collision sensor 1402 may include proximity sensors, such as ultrasonic, infrared, or LiDAR, to detect the distance to nearby objects and can predict imminent collisions before they occur. The collision sensor 1402 may include cameras equipped with image processing software to recognize obstacles. The collision sensor 1402 may include a pressure sensor to measure the force of physical contact. The collision sensor 1402 may include radar sensors to monitor the speed and distance of approaching objects.

Upon receiving an indication of a collision (or imminent collision) from the collision sensor 1402, the controller 210 transmits an instruction to control the actuator 414 to stop or reverse direction, for example, until the controller 210 is no longer receiving the indication of collision (e.g., until the collision sensor 1402 no longer detects a collision or imminent collision). In some embodiments, the indication of a collision may be used to automatically store in the memory 214 (e.g., the computer-readable, non-transitory storage medium) and automatically associate a first debris shield limit with the steering angle leading to the collision/imminent collision.

In some embodiments, the debris shield system 402 may include a clutch (e.g., a mechanical clutch, electronic clutch, hydraulic clutch, etc.) cooperatively coupled to the first debris shield 408 to disengage the first debris shield 408 from continuing to adjust in position (e.g., either pivotally or laterally) upon receiving a force satisfying a threshold force (e.g., 5, 10, 25 pounds). The clutch may be included in the debris shield system 402 (e.g., a mechanical clutch, hydraulic clutch, shear pin) or the control system 96 (e.g., an electronic clutch that stops transmitting instructions to further adjust the first debris shield 408 against the received force satisfying the threshold force). For example, a mechanical clutch may be cooperatively coupled to the first debris shield 408 at an interface between the mount 428 and the connecting member 422, the connecting member 422 and the mount 418, or the actuator 414 and its coupled components. Upon a component within the debris shield system 402 (e.g., the first debris shield 408) receiving a force that satisfies the threshold force (e.g., upon adjusting in position until colliding with an external object such as a tree), the clutch engages (e.g., either mechanically disengages or electronically disconnects) such that it does not continue movement against the threshold-satisfying force.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below,” “left,” “right,” “front,” “back”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more computer-readable, non-transitory storage medium (e.g., RAM, ROM, Flash memory, hard disk storage) for storing data and/or computer code for completing or facilitating the various processes, layers and modules described in the present disclosure. The memory/computer-readable, non-transitory storage medium may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the driveline 50, the braking system 100, the debris shield system 402, etc.) as shown in the various exemplary embodiments is illustrative only. Additionally, any element disclosed in one embodiment may be incorporated or utilized with any other embodiment disclosed herein.

What is claimed is:

1. A vehicle comprising:
a chassis;
an axle coupled to the chassis;
a first tractive element coupled to the axle;
a first debris shield positioned proximate to the first tractive element;
a first actuator operatively coupled to the first debris shield;
one or more processors communicably coupled to the first actuator; and
a computer-readable, non-transitory storage medium containing instructions that when executed by the one or more processors cause the one or more processors to perform a method of steps comprising:
receiving steering data including a steering angle of the first tractive element; and
controlling the first actuator to adjust the first debris shield from a first debris shield first position to a first debris shield second position based in part on the steering angle received in the steering data.

2. The vehicle of claim 1, further comprising:
an operator seat;
wherein the first debris shield extends circumferentially about at least a portion of the first tractive element such that the first debris shield is positioned, at least in part, between the operator seat and the first tractive element along a tractive element axis of the first tractive element.

3. The vehicle of claim 2, wherein controlling the first actuator includes transmitting a first instruction to the first actuator that causes the first actuator to maintain an orientation relative to the first tractive element.

4. The vehicle of claim 3, wherein the orientation relative to the first tractive element is such that the first debris shield maintains a position between the operator seat and the first tractive element during steering of the first tractive element.

5. The vehicle of claim 1, wherein the method further comprises receiving the steering data from a steering sensor that measures a position of a steering column of the vehicle.

6. The vehicle of claim 1, further comprising:
a steering arm operatively coupled to the first tractive element;
wherein the method further comprises receiving the steering data from a steering sensor configured to detect a position of the steering arm.

7. The vehicle of claim 1, wherein the method further comprises:
setting a first debris shield limit for the first debris shield associated with a threshold steering angle;
receiving an indication that a current steering angle is at the threshold steering angle; and
in response to at least receiving the indication that the current steering angle is at the threshold steering angle, controlling the first actuator to stop adjusting the first debris shield.

8. The vehicle of claim 7, further comprising:
a second tractive element coupled to the axle;
a second debris shield positioned proximate to the second tractive element; and
a second actuator operatively coupled to the second debris shield;
wherein the method further comprises:
controlling the second actuator to adjust the second debris shield from a second debris shield first position to a second debris shield second position based in part on the steering angle; and
in response to receiving the indication that the current steering angle is at the threshold steering angle, controlling the second actuator to continue adjusting the second debris shield to a second debris shield third position.

9. The vehicle of claim 1, wherein the method further comprises:
determining a first debris shield desired position based in part on the steering angle;
comparing a first debris shield angle of the first debris shield with the first debris shield angle; and
in response to at least the first debris shield angle exceeding a threshold from the steering angle of the first tractive element, controlling the first actuator to adjust the first debris shield to the first debris shield desired position.

10. The vehicle of claim 9, wherein the method further comprises:
receiving front implement data including a front implement position of a front implement coupled to the vehicle;
comparing the front implement position and the first debris shield angle;
determining the first debris shield desired position based in part on the steering angle and the front implement position; and
controlling the first actuator to adjust the first debris shield to the first debris shield first position.

11. The vehicle of claim 1,
receiving an indication of a collision; and
controlling the first actuator to reverse movement of the first actuator until no longer receiving the indication of the collision.

12. The vehicle of claim 1, wherein the first debris shield is mechanically decoupled from an articulation of the first tractive element.

13. The vehicle of claim 1, wherein actuation of the first debris shield is mechanically decoupled from articulation of the first tractive element.

14. The vehicle of claim 1, wherein the method further comprising:
receiving a tread setting of the vehicle; and
determining a first debris shield limit based at least in part on the tread setting.

15. The vehicle of claim 1, further comprising a clutch cooperatively coupled to the first debris shield and adapted to engage in response to receiving force satisfying a threshold force.

16. The vehicle of claim 1, wherein the method further comprises:
receiving speed data including a current speed of the vehicle; and
in response to the current speed not satisfying a speed threshold, controlling the first actuator to adjust the first debris shield to a third position such that in the third position the first debris shield is misaligned with the first tractive element.

17. The vehicle of claim 1, wherein the method further comprises:
receiving speed data including a current speed of the vehicle; and
in response to the current speed not satisfying a speed threshold, controlling the first actuator to rotate the first debris shield circumferentially about the first tractive element.

18. The vehicle of claim 1, further comprising:
determining the steering angle of the first tractive element based at least in part on the steering data; and
in response to determining the steering angle of the first tractive element, transmitting a first instruction to the first actuator to adjust a position of the first debris shield.

19. A system comprising:
a debris shield;
an actuator operatively coupled to the debris shield;
one or more processors communicably coupled to the actuator; and
a computer-readable, non-transitory storage medium containing instructions that when executed by the one or more processors cause the one or more processors to perform a method of steps comprising:
receiving steering data including a steering angle of a tractive element; and
controlling the actuator to adjust the debris shield from a debris shield first position to a debris shield second position based in part on the steering angle received in the steering data.

20. A method of operating an agricultural vehicle, the method comprising:
receiving, by one or more processors, steering data of the agricultural vehicle that includes a steering angle of a tractive element of the agricultural vehicle;
determining, by the one or more processors, a debris shield desired position based at least in part on the steering angle of the tractive element of the agricultural vehicle; and
controlling an actuator to adjust a first debris shield coupled to the agricultural vehicle from a debris shield first position to a debris shield second position based in part on the debris shield desired position.
